(19) United States
(12) Patent Application Publication
(10) Pub. No.: US 2025/0148001 A1
(43) Pub. Date: May 8, 2025

(54) COMPUTER-IMPLEMENTED METHOD FOR GENERATING DOMAIN SPECIFIC TRAINING DATA FOR A LARGE LANGUAGE MODEL

(71) Applicant: Siemens Industry Software NV, Leuven (BE)

(72) Inventors: Daniel Berger, Nürnberg (DE); Kai Liu, Heroldsberg (DE)

(21) Appl. No.: 18/940,826

(22) Filed: Nov. 7, 2024

(30) Foreign Application Priority Data
Nov. 8, 2023 (EP) 23208579.5

(51) Int. Cl. G06F 16/36; G06F 40/284

(52) U.S. Cl. CPC G06F 16/367; G06F 40/284

(57) ABSTRACT

A computer-implemented method for generating domain specific training data for a large language model includes providing a domain specific ontology relating to the domain, providing domain specific information relating to the domain, and processing the domain specific information in a data processing-pipeline for structuring data for training of the large language model. The domain specific ontology is provided as a recognition pattern in a step of the data processing-pipeline, such that the structured training data includes domain specific ontology annotations.

This application claims the benefit of European Patent Application No. EP 23208579.5, filed on Nov. 8, 2023, which is hereby incorporated by reference in its entirety.

### FIELD

The present embodiments relate to generating domain specific training data for a large language model. The present embodiments also relate to generating a text report of a user interaction with a software application running on a computer.

Natural Language Processing (NLP) has made great progress in recent years in generating texts of astonishing quality, especially since the introduction of transformer architectures.

Unlike traditional recurrent neural networks (RNNs), transformers do not require sequential processing of input data, making transformers highly parallelizable and efficient for training with large data sets. Transformers consist of multiple layers of neural networks for self-attention and feed-forward, which allow the transformers to model complex relationships between words and capture far-reaching dependencies in the input text. Transformer architectures have become the backbone of many cutting-edge language models, such as OpenAI's generative pre-trained transformer [GPT] models. Transformers achieve this performance through the use of self-attention mechanisms that allow the model to focus on different parts of the input sequence when making predictions. By taking care of relevant words, transformers may better understand the context and meaning of a particular piece of text.

NLP is a field of artificial intelligence that focuses on the interaction between computers and humans through natural language. NLP involves the development of algorithms and techniques that enable computers to understand, interpret, and generate human language. NLP includes various tasks such as text classification, sentiment analysis, machine translation, speech recognition, and question-answering systems. NLP is used in many applications, including virtual assistants, chatbots, language translation services, and information retrieval systems.

Large language models [LLM] are statistical models used in NLP to predict the probability of a sequence of words or phrases in a given context. LLMs are trained on large amounts of text data and may be used for tasks such as speech generation, machine translation, speech recognition, and more.

Such LLMs have become the state of the art in conversational AI, which may generate not only text but also executable source code (see, “Gemini”, January 2022, Online, Available: https://www.persona-ai.com/gemini).

In their most recent form (e.g., ChatGPT), these models are widely regarded as the chatbot of the future, a kind of digital omniscient companion. In the engineering world, a major technical problem is understanding how to train an LLM for an industrial or technical context. The industrial application is conservative and often safety-critical, requiring a higher quality. In addition, such industrial LLMs will get in touch with subject matter experts. Therefore, the result of these LLMs is to meet the standards of domain experts in terms of precision and conciseness in order to be useful.

Despite the undeniable and astonishing achievement, all LLMs suffer from ambiguities in language (e.g., the word “bat” has at least two different meanings) during training and inference. If the text fragment is embedded in enough context, such ambiguities may be resolved (e.g., by using the preceding and following sentences). However, the ability to analyze context requires billions of parameters that are to be trained on a huge amount of data. In fact, the highest-performing LLMs are trained on much of the written information collected worldwide (see, “The Next Generation of Large Language Models”, Feb. 7, 2023, Available: https://www.forbes.com/sites/robtoews/2023/02/07/the-next-generation-of-large-language-models/?sh=48731db618db).

Engineering language is very precise but fragmented, and often borrows concepts and vocabulary from neighboring disciplines (e.g., a setup in system simulation software is often referred to as a “circuit”). An LLM, even if trained with all the technical texts in the world, would understand and further refer to a(n) “(electrical) circuit” and therefore also use words such as voltages and currents. This problem of ambiguity is exacerbated for understanding a particular application programming interface (API) and generating snippets of code in that API because naming the API functional scope is arbitrary.

### BACKGROUND

A set of LLMs may be trained with different subsets of training data. During inference, an additional machine learning (or statistical) model may be used to recognize the domain, which may then evoke a domain specific LLM. An LLM for English input/output is trained with English texts, and similarly, an LLM for German input/output is trained with German texts. If ChatGPT is asked to generate code in Python, a specific python model is evoked, mutatis mutandis for Java, etc. This setup is often referred to as sparse expert model or massive sparse expert model. A sparse expert model is a type of machine learning model that is configured to handle sparsity in the input data. Sparsity refers to situations where most of the input features or dimensions have zero or very low values.

One issue is that for many specific domains (e.g., system simulation engineering), there is simply not enough training data in text that an LLM may be trained reliably with to meet the particularly high standards in engineering.

Another possibility may be to train an LLM with a vast amount of text from the general engineering domain, and further fine-tune the model to specific domains by adding human-in-the-loop supervised and human-in-the-loop reinforcement learning on top, similar to what is done to bring ChatGPT to its level (see: https://en.wikipedia.org/wiki/ChatGPT#:˜:text=10%20External %20links-,Training,to%20improve %20the%20model's%20performance (Online)).

The human in the loop, however, is to have expert knowledge from the specific domain, rendering this approach unfeasible (or at least not economical) for most engineering applications. The initial investment to train the model would be huge and requires too much time to pay off for the large-scale service provider (e.g., “hyperscaler”) to be interested in that domain.

Since LLMs have the capability to absorb information during an instance (e.g., a chat conversation), loading an instance and teaching it with lots of domain knowledge upfront is a valid option. But, that capability is pretty limited: even ChatGPT can only remember a few thousand tokens back in conversation (4 tokens≈3 words), rendering it impossible to remember, for example, the manual for a complex product (e.g., Simcenter Amesim).

In the context of NLP, the preparation of training data may be referred to as the NLP pipeline, which refers to the sequence of steps involved in processing and analyzing text data to extract meaningful information from textual input. The NLP pipeline typically may include the following steps. Text preprocessing involves cleaning and preparing the text data by removing unnecessary characters, punctuation, and stopwords, and converting the text to a standardized format. In tokenization, the text is divided into individual words or tokens to facilitate further analysis. Tokens may be sentences, words, or even subwords, depending on the specific application. Part-of-speech tagging assigns grammatical tags to each word in the text, indicating their syntactic role, such as noun, verb, adjective, etc. Named entity recognition (NER) identifies and classifies named entities in the text, such as person names, organizations, locations, dates, etc. Dependency parsing analyzes the grammatical structure of the text and establishes the relationships between words, identifying the subject, object, and modifiers in the sentence. Sentiment analysis determines the sentiment or emotional tone expressed in the text, classifying the text as positive, negative, or neutral. Text classification assigns predefined categories or labels to the text based on its content, such as topic classification, spam detection, or sentiment classification. Information extraction involves extracting specific information or structured data from unstructured text, such as extracting entities, relationships, or events. Language modeling focuses on predicting the next word or sequence of words in the text based on the patterns and context learned from a given dataset.

The specific steps and their order may vary depending on the NLP task and the requirements of the application. The NLP pipeline provides a systematic approach to process and analyze text data, enabling the extraction of useful insights and information.

### Summary and Description

The scope of the present invention is defined solely by the appended claims and is not affected to any degree by the statements within this summary.

The present embodiments may obviate one or more of the drawbacks or limitations in the related art. For example, an LLM tailored to a specific domain is provided. As another example, such an LLM may be linked to a domain-specific API of engineering software.

The present embodiments provide a method including the acts of: providing a domain specific ontology relating to the domain; providing domain specific information relating to the domain; and processing the domain specific information in a data processing-pipeline for structuring data for training of the large language model, where the domain specific ontology is provided as a recognition pattern in an act of the data processing-pipeline, such that the structured training data includes domain specific ontology annotations.

The main benefit of this training data generation lies in the improved performance of the trained LLM (e.g., in the field of any engineering domain of the domain specific ontology).

An ontology is a formal representation of knowledge that defines the concepts and relationships within a particular domain. The ontology aims to capture the meaning and semantics of the entities and their relationships. An ontology may consist of a hierarchical structure with classes, subclasses, and properties. The ontology provides a rich, detailed representation of knowledge and may be used for reasoning and inference.

Ontology and taxonomy are both methods for organizing and categorizing information. A taxonomy is a hierarchical classification system that organizes entities into categories based on their shared characteristics. The taxonomy focuses on categorization and classification rather than capturing the semantics and relationships between concepts. Taxonomies may be used for organizing and indexing information, making it easier to navigate and retrieve relevant content. Taxonomies are commonly represented as trees or hierarchies, where each category represents a specific level of abstraction.

Both ontology and taxonomy play important roles in organizing information and, even when used distinctly, share a significant intersection with regard to application, methodology, and purpose. For the sake of simplification, the term ontology herein is used to represent both ontology and taxonomy.

A beneficial embodiment of the present embodiments provides the computer-implemented method. The domain specific information includes domain specific text documents relating to the domain, where the processing-pipeline is a natural language processing pipeline for structuring data for training of the large language model. The domain specific ontology is provided as a recognition pattern in an act of named entity recognizing of the natural language processing pipeline, such that the structured training data includes domain specific ontology annotations.

Another embodiment, which is beneficial for using the LLM in connection with a software application, provides the computer-implemented method for generating software application specific training data for a large language model. The software application is related to the specific domain of a specific factual context and/or a technical and/or a physical domain. The domain specific information is provided as a software application computer program and/or a source code and/or an API definition of the software application. The processing-pipeline is a code parsing pipeline for structuring data for training of the large language model. The domain specific ontology is provided as a recognition pattern in an act of semantic analyzing of the code parsing pipeline, such that the structured training data includes domain specific ontology annotations.

An essential aspect of the present embodiments is combining large language models and semantic technologies to generate domain-specific large language models for engineering purposes.

The semantic technology may solve this problem by adding domain-specific meaning to the APIs that need be used for training of the LLM.

A simple example may illustrate this approach. “Wire” is a generic word that may have different meanings in different contexts. Considering computer aided design (CAD), such as using the Siemens product NX CAD, using semantic technology, the exact meaning for “Wire” in the mechanical domain may be easily defined. Dealing with a mechanical design in CAD that contains a wire, understanding the meaning of “wire” is necessary and its relationships to other NX concepts, such as Stock, Connector, Design, Part, Device. The explanation text of these concepts and their relationships are precisely defined in an NX CAD ontology. The APIs are to associate with the NX ontology as well, such that the domain-specific knowledge given in the domain specific terminology may be captured precisely.

In the following, this concept is explained in detail. The following acts may be performed when training an LLM with a set of text documents and domain-specific ontologies: A text document is pre-processed and transformed to a format that may be understood by subsequent steps (e.g., JSON). The pre-processed document is fed into a tokenizer that splits the sentences into words. A parts-of-speech (POS) tagger takes the list of words and classifies the words to different parts (e.g., nouns, verbs, adjectives). A named-entity recognition (NER) engine takes the tagged words and classifies the tagged words into pre-defined categories. The domain-specific ontology (e.g., and taxonomy) is fed into the engine as well in order to associate the International Resource Identifier (IRI) defined in the ontology to the words. The words are postprocessed and constitute well-formed training data for an LLM.

In one embodiment, in parallel, a similar flow may be executed in a code parsing pipeline where the following acts are performed: The source code is passed to a lexer that tokenizes the code and generates a stream of tokens. The parser takes the stream of tokens and turns the stream of tokens into an abstract syntax tree (AST), which is the representation of the source code and its meaning. After the parsing, a semantic analyzer gathers semantic information from the source code, including type-checking. The domain-specific ontology is fed into the semantic analyzer, which annotates the AST with the IRIs in the ontology. These IRIs are unique in the specific domain, such that the words may be easily looked up and linked together between text documents and computer programs.

Herein, a semantic analyzer, also known as a semantic parser or a semantic understanding module, may be a component of NLP systems that aims to understand the meaning or semantics of text or speech. The semantic analyzer is configured to extract the underlying meaning and relationships between words, phrases, and sentences in order to enable better comprehension and interpretation.

Known semantic analyzers use various techniques and algorithms to analyze the structure, context, and semantics of language. The known semantic analyzers may employ methods such as syntactic parsing, part-of-speech tagging, named entity recognition, word sense disambiguation, and semantic role labeling. These techniques help identify the syntactic and semantic elements in a sentence or text, such as subject, object, verb, and their relationships.

The output of a semantic analyzer may be a representation of the meaning of the input text, such as a semantic graph or a structured representation that may be further processed by downstream NLP tasks such as question answering, information retrieval, or machine translation.

The output of both pipelines constitutes training data, respectively, which is semantically aligned through a common ontology. This semantic alignment of both training data pipelines improves the efficiency of the training of the LLM significantly. The training may be provided as input to any state-of-the-art training pipeline to train the final domain specific LLMs. The actual specifics of the training pipeline are not subject of this disclosure.

The method according to the present embodiments may be implemented for different applications. Examples for such applications are: a digital assistant for simulations tasks, which has an expert understanding of, for example, how to tune simulation models for obtaining quick and reliable results, observing engineering work, and automatically generating reports and documentations, automation engineering advisor, which knows how to select an optimal hardware configuration by considering both functional and non-functional requirements, engineering advisor for optimizing PLC programs in terms of performance and memory consumption, engineering advisor analyzing the hardware and software engineering artifacts, and generating reports for the current engineering project.

Such implementations may result in a digital companion (e.g., respectively an LLM) for the respective engineering application.

Further, in accordance with the present embodiments, a computer system prepared for carrying out the method is provided.

The computer-system relates to a computer or a computer-system including at least one processor and at least one memory coupled to the at least one processor. The at least one memory stores a set of instructions to be executed by the at least one processor. The set of instructions, when executed by the at least one processor, cause the system to perform the acts according to the present embodiments. The computer system may be a single computer or a computer system consisting of multiple computers that are connected to each other, such as through the World Wide Web or another network configuration. In one embodiment, the simulation may be distributed across the computer system such that the computational work is divided among several computers, processors. Such implementation enables a fast and flexible engineering support that may be available on any computing platform.

Further, in accordance with the present embodiments, there is provided a machine including a user input interface and a user interaction recording module for recording user interaction into a data file. The machine includes a processor configured and prepared to perform the method according to the above explanations. The machine includes an output interface to output the user action report. The automatic reporting function may save the effort to document the user actions and enables understanding the user interaction even for personnel not knowledgeable about using the machine interaction reported.

An embodiment of the machine includes a user input interface according to above explanations, where the output interface is a human machine interface (e.g., a display). Using a display may be beneficial since displays are mostly available. Alternatively, the report may be consumed by listening to an audio file that may beneficially be automatically generated from the text report.

### BRIEF DESCRIPTION OF THE DRAWINGS

FIG. 1 shows a block diagram illustrating an embodiment without detail;

FIG. 2 shows a block diagram illustrating two parallel pipelines for generating training data according to an embodiment;

FIG. 3 shows a block diagram illustrating an application example involving an engineering software;

FIG. 4 shows a block diagram illustrating an application example involving an automation environment; and

FIG. 5 shows details of introducing ontology information into training data.

The illustration in the drawings is in schematic form. In different figures, similar or same elements may be provided with the same reference signs.

### DETAILED DESCRIPTION

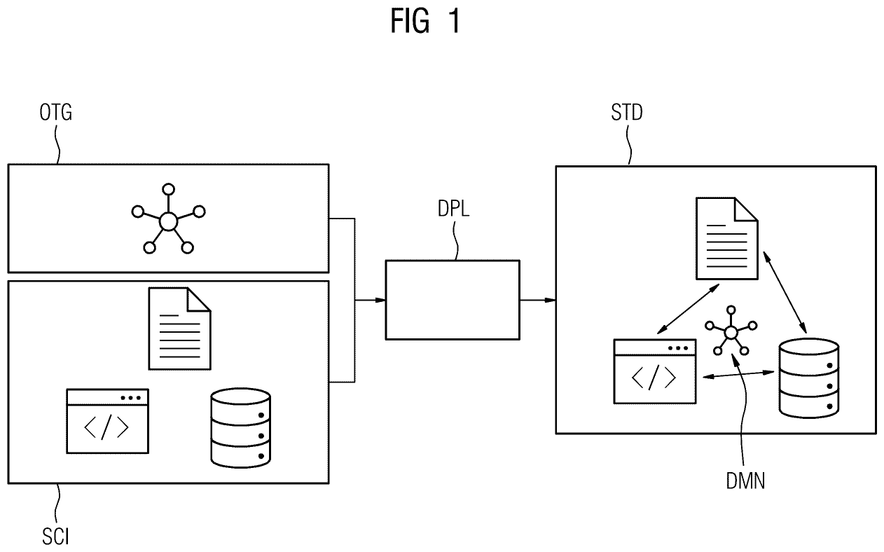

FIG. 1 shows the general concept of a computer-implemented method for generating domain DMN specific training data TRD for a large language model LLM according to the present embodiments. A domain DMN specific ontology OTG relating to the domain DMN is provided. In basically the same instance domain DMN, specific information SCI relating to the domain DMN is provided. Based on the ontology OTG, the domain DMN specific information SCI is restructured and annotated in a data processing-pipeline DPL with domain DMN specific ontology-based context and provided as semantic structured training data STD for training of a large language model LLM in the specific domain DMN.

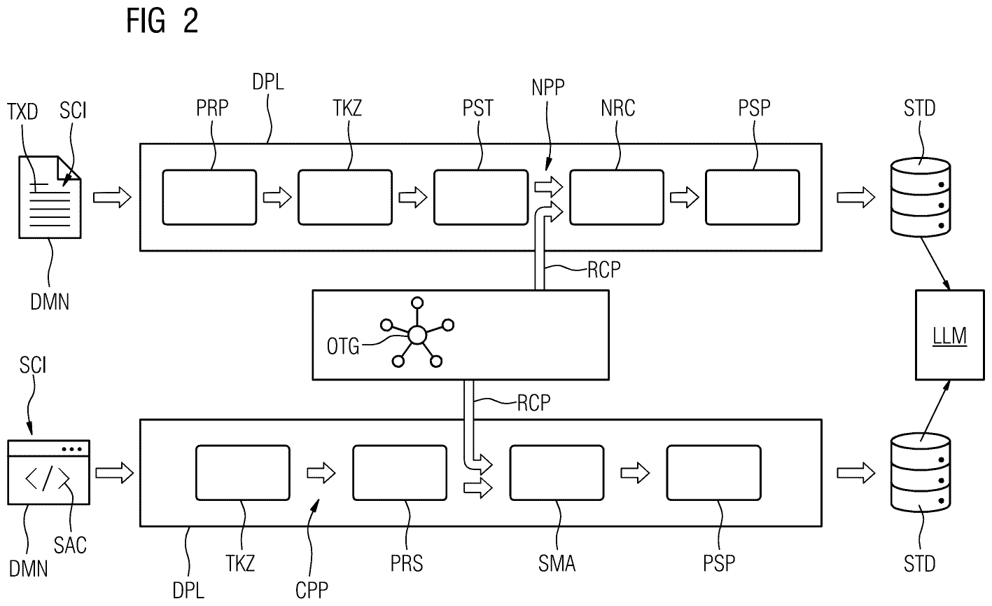

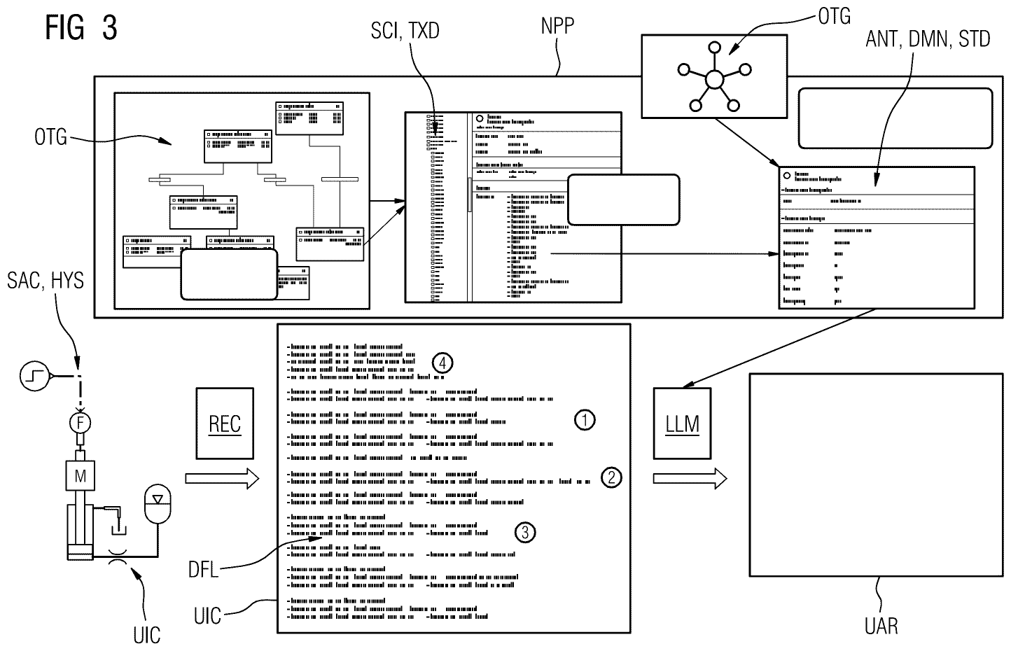

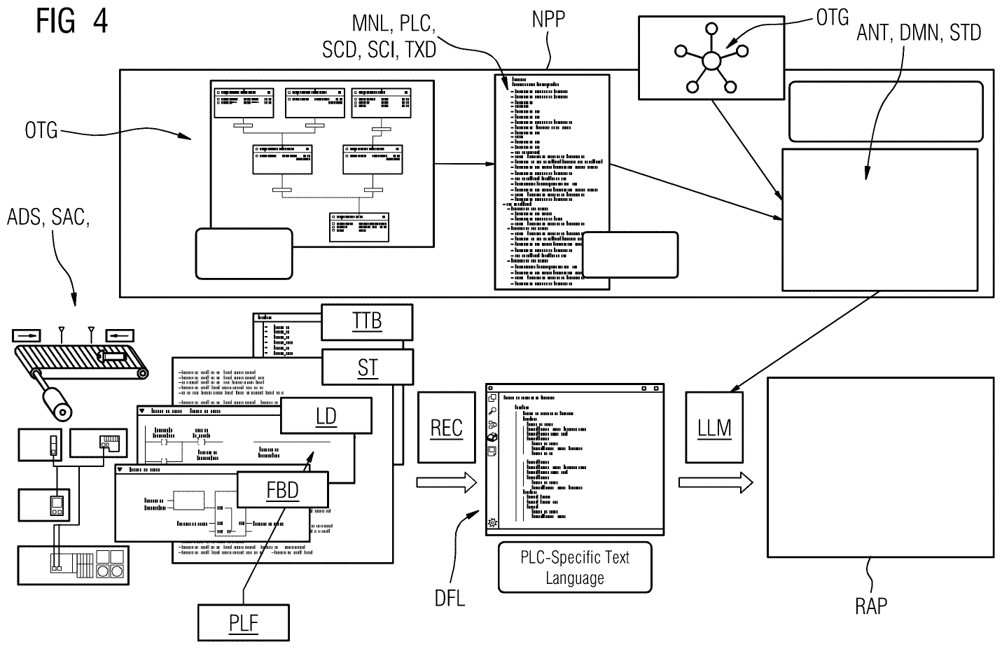

As illustrated in FIG. 2 in more detail, the domain DMN specific information SCI is processed in a data processing-pipeline DPL for structuring data for training of the large language model LLM, such that the structured training data STD includes domain DMN specific ontology OTG annotations ANT. Subsequently, the method includes an act of training TRN the large language model LLM using the structured training data STD including domain DMN specific ontology OTG annotations ANT as illustrated in the examples presented in FIGS. 3 and 4.

FIG. 2 shows how the domain DMN specific ontology OTG is provided as a recognition pattern RCP in two different data processing-pipelines DPL shown in the upper and lower part of FIG. 2.

In the upper part of FIG. 2, domain DMN specific information SCI includes domain DMN specific text documents TXD relating to the domain DMN.

Shown processing-pipeline is a natural language processing pipeline NPP for structuring data for training of the large language model LLM. The natural language processing pipeline NPP includes the acts of preprocessing PRP, tokenizing TKZ, part-of-speech-tagging PST, named entity recognizing NRC, and post-processing PSP.

A domain DMN specific ontology OTG is provided as a recognition pattern RCP in an act of named entity recognizing NRC of the natural language processing pipeline NPP, such that the structured training data STD includes domain DMN specific ontology OTG annotations ANT.

In the lower part of FIG. 2, the domain DMN specific information SCI is provided as a software application computer program SAC and/or a source code SRC and/or an API definition APD of the software application. The software application is related to the specific domain DMN of a specific factual context and/or a technical and/or a physical domain DMN. The processing-pipeline is a code parsing pipeline CPP for structuring data for training of the large language model LLM. The code parsing pipeline CPP includes the acts of tokenizing TKZ, which may also be termed a lexer, parsing PRS, semantic-analyzing SMA, and post-processing PSP. The domain DMN specific ontology OTG is provided as a recognition pattern RCP in an act of semantic analyzing SMA of the code parsing pipeline CPP, such that the structured training data STD includes domain DMN specific ontology OTG annotations ANT.

FIG. 3 shows an application example of the method according to the present embodiments. The software application computer program SAC is Amesim provided by Siemens, which is used to develop, investigate, and improve systems with a variety of multiphysics subcomponents. The software provides a holistic view of the interaction of mechanical, hydraulic, pneumatic, thermal, electrical, and electronic parts. The manual and the source code of Amesim are processed according to the present embodiments together with a domain specific ontology. A large language model LLM is trained with the structured training data STD including domain DMN specific ontology OTG annotations ANT.

In a second phase, the trained large language model LLM is used to generate a user action report UAR. In this example, a hydraulic suspension HYS design is modified by a user USR of the software application computer program SAC Amesim. The user interaction UIC is recorded REC in a data file DFL, and the data file DFL is processed by the trained large language model LLM to generate a user action report UAR.

FIG. 4 shows a similar example of applying the method according to the present embodiments as FIG. 3 relating to an application of automation design. The software application computer program SAC is an automation design software ADS. A manual MNL and a source code SCD of the automation design software are processed as domain DMN specific information SCI according to the present embodiments together with an automation domain specific ontology OTG that includes a taxonomy of programming language PLC instructions. A large language model LLM is trained with the structured training data STD including domain DMN specific ontology OTG annotations ANT.

In the second phase relating to the application of the trained large language model LLM, the trained large language model LLM is used for generating a text report of an automation process of a machine. The automation process of a machine is implemented as a programmable logic controller language file (e.g., written in a programming language according to IEC 61131-3). That may be at least one of a ladder diagram LD, a function block diagram FBD, a structured text ST, an instruction list, or a sequential function chart. As a next act, a data file DFL in a programmable logic controller semantics is generated from the programmable logic controller language file PLF. The data file DFL is processed by the trained large language model LLM to generate the text report of an automation process RAP.

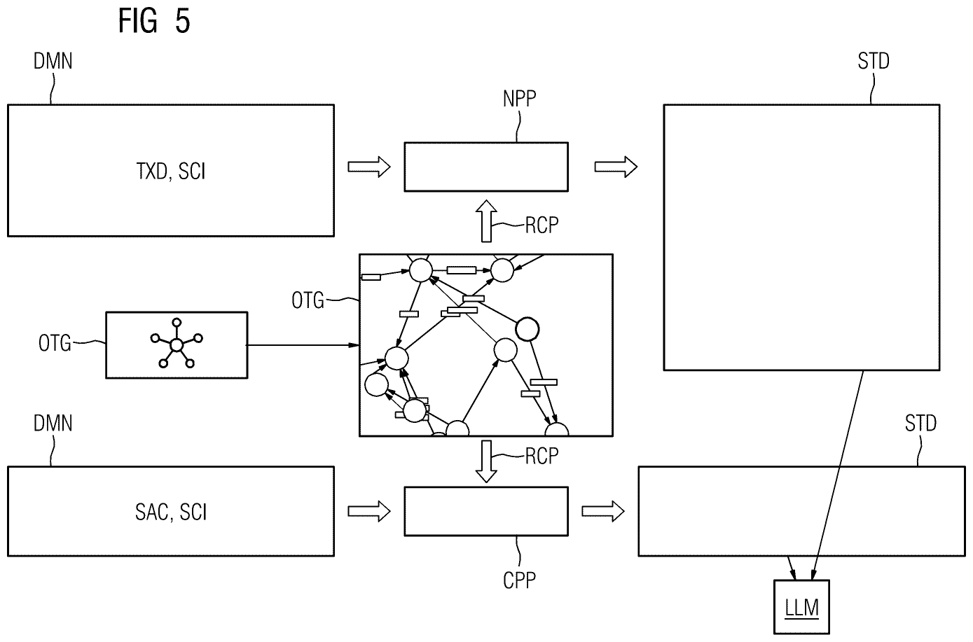

FIG. 5 shows by way of example a natural language processing pipeline NPP and a code parsing pipeline CPP for structuring data for training of the large language model LLM.

This example starts from a computer software documentation or manual describing the function of an engineering application, such as “Amesim Automotive Electrics library documentation.” The description may contain text such as: “The automotive electrics library provides various models to model automotive on-board networks such as energy generators alternator, energy stocking systems battery, energy consumer loads, connections wires, fuses . . . . Three levels of detail are available quasi-static, slow transient, fast transient. From simple energetic behavior to precise high frequency dynamics modeling. Automotive electronics design can be improved with the automotive electronics library and the Simcenter Amesim environment thanks to the representation of electrical, thermal and mechanical phenomena.”

A domain specific ontology is provided.

Combining the description with the ontology in the NLP-pipeline results in the documentation with ontology annotation as structured training data STD in json-format, which may be like the following: {“id”: “libae/ae”, “url”: “/libae/doc/ae.html”, “title”: “Automotive Electrics library”, “text”: “The Automotive Electrics library provides various models to model automotive on-board networks such as: energy generators alternator, energy stocking system battery, energy consumer loads, connection wires, fuses . . . Three levels of detail are available: quasi-static, slow transient, fast transient. From simple energetic behavior to precise high frequency dynamics modeling, automotive electrics designs can be improved with the Automotive Electrics library and the Simcenter Amesim environment thanks to the representation of electrical, thermal and mechanical phenomena”, “tag”: “http://ontology.siemens.com/disw/amesim#Library”}

In parallel, a code parsing pipeline CPP processes an API definition of Amesim AMEGetLibrarylconGeometry, resulting in the structured data for training of the large language model LLM:

{″Module″:{″body″:[{″Expr″:{″value″:{″Call″:{″args″:[{″Constant″:{″kind″:null,″
value″:″meca.mass2port″}}],″func″:{″Name″:{″ctx″:″Load″,″id″:″AMEGetLibraryIcon
Geometry″,″tag″:″http://ontology.siemens.com/disw/amesim#Library″}},″keywords″:
[ ]}}}}],″type_ignores″:[ ]}}

Although the present invention has been described in detail with reference to the example embodiments, it is to be understood that the present invention is not limited by the disclosed examples, and that numerous additional modifications and variations may be made thereto by a person skilled in the art without departing from the scope of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for generating domain specific training data for a large language model, the computer-implemented method comprising:
providing a domain specific ontology relating to a domain;
providing domain specific information relating to the domain; and
processing the domain specific information in a data processing-pipeline for structuring data for training of the large language model,
wherein the domain specific ontology is provided as a recognition pattern in a step of the data processing-pipeline, such that the structured training data comprises domain specific ontology annotations.

2. The computer-implemented method of claim 1, wherein the domain specific information comprises domain specific text documents relating to the domain,
wherein the processing-pipeline is a natural language processing pipeline NPP for structuring data for training of the large language model, and
wherein the domain specific ontology is provided as a recognition pattern in a step of named entity recognizing of the natural language processing pipeline NPP, such that the structured training data comprises domain specific ontology annotations.

3. The computer-implemented method of claim 1, wherein the domain specific training data is software application specific training data for the large language model,
wherein the software application is related to the domain of a specific factual context, a technical domain, a physical domain, a technical and physical domain, or any combination thereof,
wherein the domain specific information is provided as a software application computer program, source code, an API definition of the software application, or any combination thereof,
wherein the processing-pipeline is a code parsing pipeline for structuring data for training of the large language model, and
wherein the domain specific ontology is provided as a recognition pattern in a step of semantic analyzing of the code parsing pipeline such that the structured training data comprises domain specific ontology annotations.

4. The computer-implemented method of claim 2, wherein the natural language processing pipeline NPP comprises:
preprocessing, tokenizing, part-of-speech-tagging, named entity recognizing, and post-processing.

5. The computer-implemented method of claim 3, wherein the code parsing pipeline comprises:
tokenizing, parsing, semantic-analyzing, and post-processing.

6. The computer-implemented method of claim 1, further comprising:
training the large language model using the structured training data comprising domain specific ontology annotations.

7. A computer-implemented method for generating a text report from a data file, the computer-implemented method comprising:
generating domain specific training data for a large language model, the generating of the domain specific training data comprising:
providing a domain specific ontology relating to a domain;
providing domain specific information relating to the domain; and
processing the domain specific information in a data processing-pipeline for structuring data for training of the large language model, wherein the domain specific ontology is provided as a recognition pattern in a step of the data processing-pipeline, such that the structured training data comprises domain specific ontology annotations, and wherein the data file contains passages that are formulated in computer semantics;
processing the data file by the trained large language model; and
generating a human-readable text report.

8. The computer-implemented method of claim 7, wherein the text report is of a user interaction with a software application running on a computer,
wherein the computer-implemented method further comprises:
recording of user interaction, wherein the data file contains recordings of the user interaction;
processing the data file that contains the recordings of the user interaction by the trained large language model; and
generating a user action report.

9. The computer-implemented method of claim 7, wherein the text report is of an automation process of a machine being controlled by the automation process implemented as a programmable logic controller language file,
wherein the computer-implemented method further comprises:
generating the data file in a programmable logic controller semantics from the programmable logic controller language file; and
processing the data file by the trained large language model and generating the text report of the automation process.

10. The computer-implemented method of claim 9, wherein the programmable logic controller language file is written in a programming language according to IEC 61131-3.

11. A computer system comprising:
a processor; and
a data storage that stores instructions executable by the processor to generate domain specific training data for a large language model, the generation of the domain specific training data comprising:
provision of a domain specific ontology relating to a domain;
provision of a domain specific information relating to the domain; and
process of the domain specific information in a data processing-pipeline for structuring data for training of the large language model,
wherein the domain specific ontology is provided as a recognition pattern in a step of the data processing-pipeline, such that the structured training data comprises domain specific ontology annotations.

12. A machine comprising:
a user input interface;
a user interaction recording module for recording user interaction into a data file;
a processor configured to:
generate a text report from a data file, the generation of the text report comprising:
generation of domain specific training data for a large language model, the generation of the domain specific training data comprising:
provision of a domain specific ontology relating to a domain;
provision of a domain specific information relating to the domain; and
process of the domain specific information in a data processing-pipeline for structuring data for training of the large language model, wherein the domain specific ontology is provided as a recognition pattern in a step of the data processing-pipeline, such that the structured training data comprises domain specific ontology annotations, and wherein the data file contains passages that are formulated in computer semantics;
process of the data file by the trained large language model;
generation of a human-readable text report, wherein the human-readable text report is of an automation process of a machine being controlled by the automation process implemented as a programmable logic controller language file;
generation of the data file in a programmable logic controller semantics from the programmable logic controller language file; and
process of the data file by the trained large language model and generating the text report of the automation process; and
an output interface configured to output the user action report.

13. The machine of claim 12, wherein the output interface is a human machine interface.

14. The machine of claim 13, wherein the human machine interface comprises a display.
